(19) United States
(12) Patent Application Publication
(10) Pub. No.: US 2025/0051141 A1
(43) Pub. Date: Feb. 13, 2025

(54) ESCALATOR ENTRAPMENT DETECTION SYSTEM

(71) Applicant: Otis Elevator Company, Farmington, CT (US)

(72) Inventors: Randall Roberts, Hebron, CT (US); Johanna Whitwell, Hartford, CT (US)

(21) Appl. No.: 18/447,488

(22) Filed: Aug. 10, 2023

(51) Int. Cl. B66B 29/02; B66B 21/04; B66B 25/00; B66B 27/00; G08B 21/18

(52) U.S. Cl. CPC B66B 29/02; B66B 21/04; B66B 25/003; B66B 27/00; G08B 21/18

(57) ABSTRACT

An escalator system is provided and includes a balustrade including a skirt with a brush, a moving step, which is drivable to move in a conveyance direction along the balustrade to form a step-skirt interface between ends of the brush of the skirt and a corresponding side of the moving step, and an entrapment monitoring and detection system. The entrapment monitoring and detection system includes a sensor and a processor. The sensor is disposed at the step-skirt interface and is configured to sense an object being present at the step-skirt interface. The processor is configured to determine whether the sensor senses the object being present at the step-skirt interface for a predetermined time.

### BACKGROUND

The present disclosure relates to escalator systems and, in particular, to a system and method that provide for LiDAR-based entrapment detection.

Conveyors of people, such as escalators and moving walkways, usually include a conveyance band that moves with people standing on it between opposing landing zones, driving machines that drive movement of the conveyance band, combplates at each of the landing zones, balustrades on either side of the conveyance band and outer skirts. The conveyance band can be configured to form multiple moving steps that move between the opposing landing zones. Each of the moving steps can have a surface that includes cleats and grooves. The combplates are provided at the opposing landing zones. Each combplate includes teeth that extend into the grooves of the surface of the conveyance band as the conveyance band moves relative to each combplate and the cleats move along each of the teeth. The outer skirts are supported on the balustrades on either side of the conveyance band between the landing zones. The outer skirts are typically stationary relative to the moving steps.

The interface between each of the moving steps and the stationary outer skirts on an escalator has long been a safety risk for entrapments due to the relative motion of the moving steps and the stationary outer skirts. One way to address but not necessarily solve this issue has been the use of brushes on the stationary outer skirts to make passengers aware of the potential for entrapment.

Therefore, since the use of brushes does not solve the problem of entrapment between the moving steps of an escalator and the outer skirts, a need exists for a system and method that provide for detection of potential/imminent step-skirt entrapments and a focused and directed warning to avoid a true entrapment.

### SUMMARY

According to an aspect of the disclosure, an escalator system is provided and includes a balustrade including a skirt with a brush, a moving step, which is drivable to move in a conveyance direction along the balustrade to form a step-skirt interface between ends of the brush of the skirt and a corresponding side of the moving step, and an entrapment monitoring and detection system. The entrapment monitoring and detection system includes a sensor and a processor. The sensor is disposed at the step-skirt interface and is configured to sense an object being present at the step-skirt interface. The processor is configured to determine whether the sensor senses the object being present at the step-skirt interface for a predetermined time.

In accordance with additional or alternative embodiments, the sensor includes multiple sensors that sense in a same direction or in multiple directions.

In accordance with additional or alternative embodiments, the sensor is a LiDAR sensor.

In accordance with additional or alternative embodiments, the sensor is a RADAR sensor.

In accordance with additional or alternative embodiments, the sensor is a camera.

In accordance with additional or alternative embodiments, the sensor is one or more of a LiDAR sensor, a RADAR sensor or a camera.

In accordance with additional or alternative embodiments, the sensor is configured to execute periodic sensing and is further configured to generate signals during the periodic sensing which are receivable and readable by the processor. When no object is present at the step-skirt interface, the signals are first signals and are reflective of a predetermined length along the balustrade for which the sensor is responsible. When an object is present at the step-skirt interface for less than the predetermined time, the signals deviate from the first signals and persist for less than the predetermined time. When an object is present at the step-skirt interface for at least the predetermined time, the signals deviate from the first signals and persist for at least the predetermined time.

In accordance with additional or alternative embodiments, the escalator system further includes light emitting diodes (LEDs) arranged along the balustrade and controllable by the entrapment monitoring and detection system to emit light in response to the processor determining that the sensor senses the object being present at the step-skirt interface for the predetermined time.

In accordance with additional or alternative embodiments, the processor is further configured to judge that an entrapment incident is in effect or is imminent in accordance with an affirmative determination that the sensor senses the object being present at the step-skirt interface for the predetermined time and to take a mitigation action accordingly and the mitigation action includes at least one or more of activating a warning light to emit a first color, activating the warning light to emit a second color and braking or slowing the escalator system.

According to an aspect of the disclosure, an escalator system is provided and includes balustrades, each including a skirt with a brush, a moving step, which is drivable to move in a conveyance direction between the balustrades to form step-skirt interfaces between ends of each brush and corresponding sides of the moving step, and an entrapment monitoring and detection system. The entrapment monitoring and detection system includes a sensor and a processor. The sensor is disposed at each step-skirt interface and is configured to sense an object being present at each step-skirt interface. The processor is configured to determine whether either sensor senses the object being present at either step-skirt interface for a predetermined time, to judge that an entrapment incident is in effect or is imminent in accordance with an affirmative determination that either sensor senses the object being present at either step-skirt interface for the predetermined time and to take a mitigation action accordingly.

In accordance with additional or alternative embodiments, the sensor at each step-skirt interface includes multiple sensors that sense in a same direction or in multiple directions.

In accordance with additional or alternative embodiments, the sensor at each step-skirt interface is a LiDAR sensor.

In accordance with additional or alternative embodiments, the sensor at each step-skirt interface is a RADAR sensor.

In accordance with additional or alternative embodiments, the sensor at each step-skirt interface is a camera.

In accordance with additional or alternative embodiments, the sensor at each step-skirt interface is one or more of a LiDAR sensor, a RADAR sensor or a camera.

In accordance with additional or alternative embodiments, the sensor at each step-skirt interface is configured to execute periodic sensing and is further configured to generate signals during the periodic sensing which are receivable and readable by the processor. When no object is present at either step-skirt interface, the signals of each sensor are first signals and are reflective of a predetermined length along the balustrades for which each sensor is responsible. When an object is present at either step-skirt interface for less than the predetermined time, the signals of the corresponding sensor deviate from the first signals and persist for less than the predetermined time. When an object is present at either step-skirt interface for at least the predetermined time, the signals of the corresponding sensor deviate from the first signals and persist for at least the predetermined time.

In accordance with additional or alternative embodiments, the escalator system further includes light emitting diodes (LEDs) arranged along each of the balustrades and controllable by the entrapment monitoring and detection system to emit light in response to the processor determining that the sensor senses the object being present at the step-skirt interface for the predetermined time.

In accordance with additional or alternative embodiments, the processor is further configured to judge that an entrapment incident is in effect or is imminent in accordance with an affirmative determination that either sensor senses the object being present at the corresponding step-skirt interface for the predetermined time and to take a mitigation action accordingly and the mitigation action includes at least one or more of activating a warning light to emit a first color, activating the warning light to emit a second color and braking or slowing the escalator system.

According to an aspect of the disclosure, a method of operating an entrapment monitoring and detection system of an escalator system in which a moving step passes by ends of a brush of a balustrade at a step-skirt interface is provided. The method includes scanning the step-skirt interface, determining whether results of the scanning are indicative of an object at the step-skirt interface, determining whether the results of the scanning are indicative of the object at the step-skirt interface persisting for a predetermined time and judging that an entrapment is in effect or imminent in accordance with the results of the scanning being indicative of the object at the step-skirt interface and persisting for the predetermined time.

In accordance with additional or alternative embodiments, the method further includes taking a mitigation action to address the entrapment being in effect or imminent and the mitigation action includes at least one or more of activating a warning light to emit a first color, activating the warning light to emit a second color and braking or slowing the escalator system.

Additional features and advantages are realized through the techniques of the present disclosure. Other embodiments and aspects of the disclosure are described in detail herein and are considered a part of the claimed technical concept. For a better understanding of the disclosure with the advantages and the features, refer to the description and to the drawings.

### BRIEF DESCRIPTION OF THE DRAWINGS

For a more complete understanding of this disclosure, reference is now made to the following brief description, taken in connection with the accompanying drawings and detailed description, wherein like reference numerals represent like parts:

FIG. 1 is a perspective view of an escalator system in accordance with embodiments;

FIG. 2 is a schematic illustration of an escalator system having an entrapment monitoring and detection system in accordance with embodiments;

FIG. 3 is a perspective view of an escalator system having an entrapment monitoring and detection system in accordance with embodiments;

FIG. 4 is a top-down view of arrangements of sensors of the entrapment monitoring and detection system of FIGS. 2 and 3 in accordance with embodiments;

FIG. 5 is a perspective view of components of the entrapment monitoring and detection system of FIGS. 2 and 3 in accordance with embodiments;

FIG. 6 is a graphical depiction of an operation of the escalator system having the entrapment monitoring and detection system of FIGS. 2-5;

FIG. 7 is a flow diagram illustrating a method of operating an entrapment monitoring and detection system of an escalator system in accordance with embodiments; and

FIG. 8 is a flow diagram illustrating a method of operating an entrapment monitoring and detection system of an escalator system in accordance with further embodiments.

### DETAILED DESCRIPTION

In escalator technology, passenger safety risks are associated with riding on escalators. These include over-crowding that can cause riders to stumble and entrapments of personal items (e.g., shoes, laces or clothing items) at the interface of moving steps and the combplate and at the interface of the moving steps and outer skirts on balustrades at either side of escalators.

Thus, as will be described below, a system and method are provided for detecting potential/imminent step-skirt entrapments and for focused and directed warning to avoid a true entrapment. An escalator is instrumented with light detection and ranging (LiDAR) sensors or other similar types of sensors on either side of the escalator. The sensors monitor straight portions of the escalator run. Multiple sensors may be used on each side to account for the potential of an entrapment case obstructing another entrapment further along the sensor focus area. Data, such as LiDAR data, would then be processed by a device to detect entrapment hazards by monitoring the range to the object and its persistence over time. This processing would result in the ability to display entrapment hazards at the moving location they are detected using, for example, a string of light emitting diodes (LEDS) where “yellow” would be a caution (object is first viewed in the step/skirt interface) and “red” would be an alarm (object persists over time, moving with the step). This caution/alarm could be displayed to the passenger and potentially used to drop the escalator brake (i.e., as a last resort).

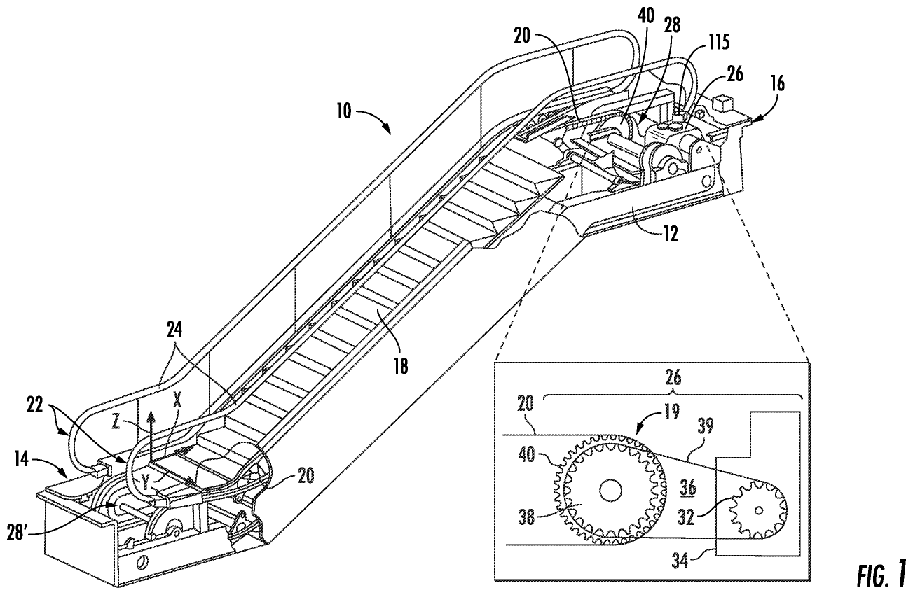

With reference to FIG. 1, an escalator 10 is provided. It should become apparent in the ensuing description that the invention is applicable to other passenger conveyor systems, such as moving walks. The escalator 10 generally includes a truss 12 extending between a lower landing 14 and an upper landing 16. A plurality of sequentially connected steps or tread plates 18 are connected to a step chain 20 and travel through a closed loop path within the truss 12. A pair of balustrades 22 are disposed on either side of the escalator 10, with each balustrade 22 including a moving handrail 24. A drive machine 26, or drive system, is typically located in a machine space 28 under the upper landing 16. An additional machine space 28′ can be located under the lower landing 14. The drive machine 26 is configured to drive the tread plates 18 and/or handrails 24 through the step chain 20. The drive machine 26 operates to move the tread plates 18 in a chosen direction at a desired speed under normal operating conditions.

The tread plates 18 make a 180 degree heading change in a turn-around area 19 located under the lower landing 14 and the upper landing 16. The tread plates 18 are pivotally attached to the step chain 20 and follow a closed loop path of the step chain 20, running from one landing to the other, and back again.

The drive machine 26 includes a first drive member 32, such as a motor output sheave, connected to a drive motor 34 through a belt reduction assembly 36 including a second drive member 38, such as an output sheave, driven by a tension member 39, such as an output belt. The first drive member 32 in some embodiments is a driving member, and the second drive member 38 is a driven member.

As used herein, the first drive member 32 and/or the second drive member 38, in various embodiments, may be any type of rotational device, such as a sheave, pulley, gear, wheel, sprocket, cog, pinion, etc. The tension member 39, in various embodiments, can be configured as a chain, belt, cable, ribbon, band, strip, or any other similar device that operatively connects two elements to provide a driving force from one element to another. For example, the tension member 39 may be any type of interconnecting member that extends between and operatively connects the first drive member 32 and a second drive member 38. In some embodiments, as shown in FIG. 1, the first drive member 32 and the second drive member may provide a belt reduction. For example, first drive member 32 may be approximately 75 mm (2.95 inches) in diameter while the second drive member 38 may be approximately 750 mm (29.53 inches) in diameter. The belt reduction, for example, allows the replacement of sheaves to change the speed for 50 or 60 Hz electrical supply power applications, or different step speeds. However, in other embodiments the second drive member 38 may be substantially similar to the first drive member 32.

As noted, the first drive member 32 is driven by drive motor 34 and thus is configured to drive the tension member 39 and the second drive member 38. In some embodiments the second drive member 38 may be an idle gear or similar device that is driven by the operative connection between the first drive member 32 and the second drive member 38 by means of tension member 39. The tension member 39 travels around a loop set by the first drive member 32 and the second drive member 38, which herein after may be referred to as a small loop. The small loop is provided for driving a larger loop which consists of the step chain 20, and is driven by an output sheave 40, for example. Under normal operating conditions, the tension member 39 and the step chain 20 move in unison, based upon the speed of movement of the first drive member 32 as driven by the drive motor 34.

The escalator 10 also includes a controller 115 that is in electronic communication with the drive motor 34. The controller 115 may be located, as shown, in the machine space 28 of the escalator 10 and is configured to control the operation of the escalator 10. For example, the controller 115 may provide drive signals to the drive motor 34 to control the acceleration, deceleration, stopping, etc. of the tread plates 18 through the step chain 20. The controller 115 may be an electronic controller including a processor and an associated memory comprising computer-executable instructions that, when executed by the processor, cause the processor to perform various operations. The processor may be, but is not limited to, a single-processor or multi-processor system of any of a wide array of possible architectures, including field programmable gate array (FPGA), central processing unit (CPU), application specific integrated circuits (ASIC), digital signal processor (DSP) or graphics processing unit (GPU) hardware arranged homogenously or heterogeneously. The memory may be but is not limited to a random access memory (RAM), read only memory (ROM), or other electronic, optical, magnetic or any other computer readable medium.

Although described herein as a particular escalator drive system and particular components, this is merely exemplary, and those of skill in the art will appreciate that other escalator system configurations may operate with the invention disclosed herein.

With reference to FIGS. 2-6, an escalator system 201 is provided. The escalator system 201 includes balustrades 210 that each includes a skirt 211 with a brush 212 (see FIG. 5), a moving step 220 and an entrapment monitoring and detection system 230. The balustrades 210, each skirt 211 and each brush 212 are stationary. The moving step 220 is drivable to move in a conveyance direction C along the balustrades 210, each skirt 211 and each brush 212. The moving step 220 thus moves between the balustrades 210 to form step-skirt interfaces 240 (see FIG. 5) between ends of each brush 212 and corresponding sides 221 of the moving step 220 (see FIG. 5). The entrapment monitoring and detection system 230 includes a sensor 231 for each step-skirt interface 240 and a processor 232. Each sensor 231 is disposed at or near to the corresponding step-skirt interface 240 and is configured to sense an object being present at the corresponding step-skirt interface 240 at any point along the corresponding balustrade 210/skirt 211/brush 212 that the sensor 231 is responsible for scanning.

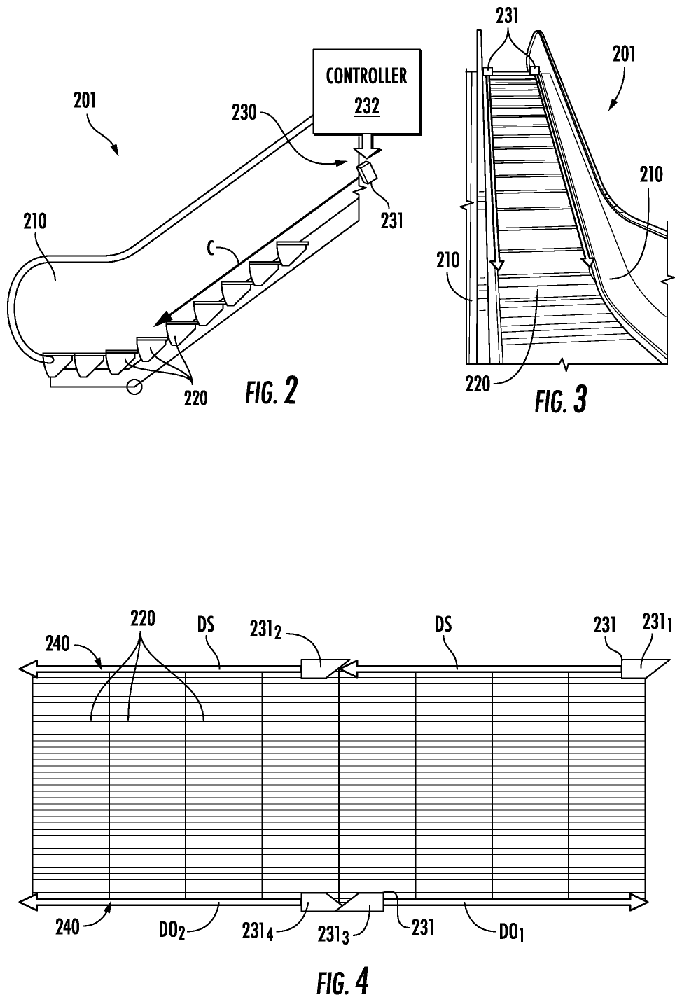

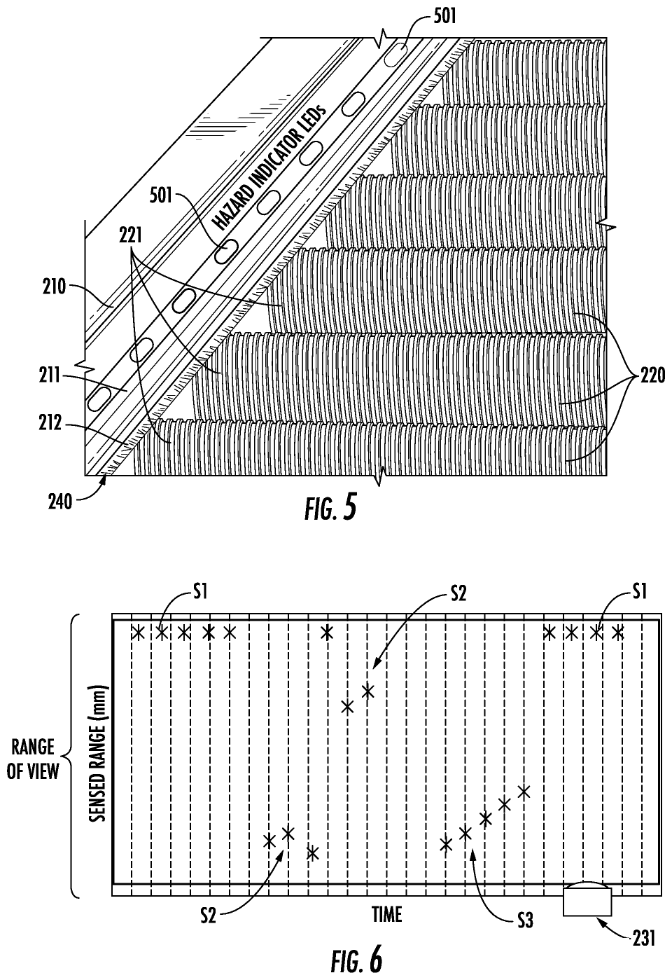

As shown in FIG. 4, the sensor 231 at each step-skirt interface 240 can include multiple sensors 231₁, 231₂ that sense in a same direction DS and/or multiple sensors 231₃, 231₄ that sense in opposite directions DO₁, DO₂. In the former case, the sensor 231₁ is responsible for sensing in the direction DS along the corresponding balustrade 210/skirt 211/brush 212 to a location of sensor 231₂ and the sensor 231₂ is responsible for sensing in the direction DS along the corresponding balustrade 210/skirt 211/brush 212 to a next sensor or to an end of the escalator. In the latter case, the sensors 231₃, 231₄ about one another, the sensor 231₃ is responsible for sensing in the direction DO₁ along the corresponding balustrade 210/skirt 211/brush 212 and the sensor 231₄ is responsible for sensing in the direction DO₂ along the corresponding balustrade 210/skirt 211/brush 212. It is to be understood that other sensors arrangements are possible and that an escalator need not have a same sensor arrangement at each step-skirt interface 240.

The processor 232 can be a component of the controller 115 of FIG. 1 and is operably coupled to the sensor 231 and includes a processing unit, a networking unit by which the processing unit is communicative with the sensor 231 and external devices and a memory. The memory has executable instructions stored thereon, which, when executed, cause the processing unit to operate as described herein. The following description will refer to the processor 232 generally.

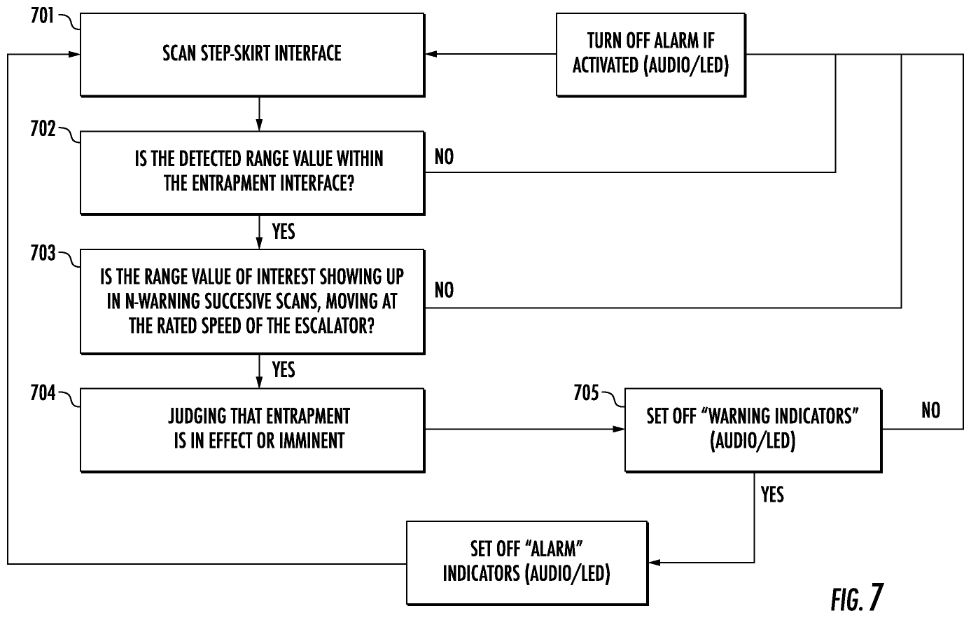

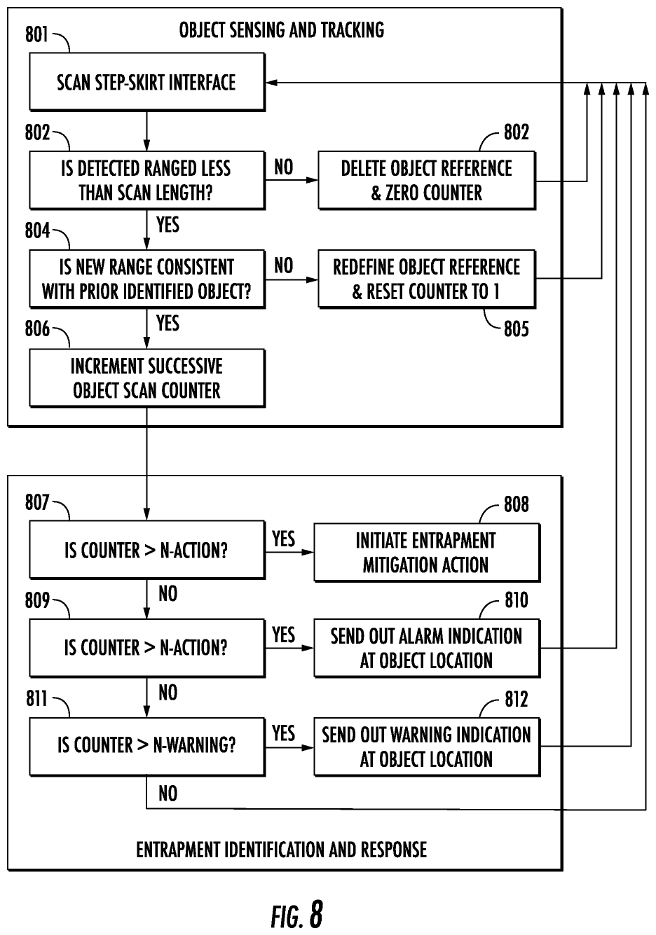

The processor 232 is configured to determine whether any sensor 231 senses the object being present at the step-skirt interface 240 for which that sensor 231 is responsible for scanning for a predetermined time. In addition, the processor 232 is further configured to judge that an entrapment incident is in effect in accordance with an affirmative determination that the sensor 231 senses the object being present at the step-skirt interface 240 for the predetermined time and to take a mitigation action accordingly. In accordance with one or more alternative embodiments, the mitigation action can include at least one or more of activating one or more local warning lights 501, which are arranged along one or both of the balustrades 210, to emit a first color (i.e., orange to denote a warning of a potential/imminent entrapment at the location of the warning light 501), activating the one or more local warning lights 501 to emit a second color (i.e., red to denote an alarm of a potential/imminent entrapment at the location of the warning light 501) and braking or slowing the escalator system (see FIG. 7) in an event of an entrapment incident being currently in effect.

In accordance with embodiments, each sensor 231 can include or be provided as one or more of a light detection and ranging or a laser imaging, detection, and ranging (LiDAR) sensor, a radio detection and ranging (RADAR) sensor and/or a camera. In accordance with further embodiments, each sensor 231 can be provided as one or more of a 2D LiDAR sensor, a millimeter wave RADAR sensor and/or a red, green, blue, depth (RGBD) camera. In accordance with still further embodiments, each sensor 231 can be provided as plural sensors as described above including a combination of one or more sensor types listed herein.

As shown in FIG. 6, which is illustrative of data that can be generated by the sensor 231, particularly where the sensor 231 is a LiDAR sensor, the sensor 231 can be configured to execute periodic sensing and can be further configured to generate the data as signals S during the periodic sensing. These signals S can be receivable and readable by the processor 232. In accordance with embodiments, the sensor 231 can periodically scan its entrapment interface ten times per second, for example, as illustrated in FIG. 6 which shows a compilation of those multiple scans so the aspect of time varying signals is introduced. When no object is present at the step-skirt interface 240 for a sensor 231, the signals S of that sensor 231 are first signals S₁ and are reflective of a length of scanning responsibility of that sensor 231 along the adjacent balustrade 210/skirt 211/brush 212. When an object is present at the step-skirt interface 240 for a sensor 231 for less than the predetermined time, which could be anywhere in the range of milliseconds to seconds or longer, the signals S of that sensor 231 deviate from the first signals S₁ and persist as second signals S₂ for less than the predetermined time. When an object is present at the step-skirt interface 240 for a sensor 231 for at least the predetermined time, the signals S of that sensor 231 deviate from the first signals S1 and persist as third signals S₃ for at least the predetermined time. As used herein, the deviation of the second signals S₂ and the third signals S₃ from the first signals S₁ manifests as data points that are not reflective of the length of scanning responsibility of the corresponding sensor 231 along the adjacent balustrade 210/skirt 211/brush 212 but rather the shorter and variable distance between the sensor 231 and the object that is present at the step-skirt interface 240. Notably, the first signals S1, the second signals S2 and the third signals S3 relate to a moving frame, which moves relative to the sensor 231, which is static. A stationary object (e.g., a shoe) on the moving step 220 will have an increasing distance from the sensor 231 if the sensor is looking along an escalator that is moving in a direction away from it. As such, “persistence” for entrapment detection would appear like the set of scans for the third signal S3 which as shown are moving away at the escalator running speed.

The processor 232 can be trained or otherwise programmed to recognize the length of scanning responsibility of that sensor 231 along the adjacent balustrade 210/skirt 211/brush 212 reflected by the first signals S₁, the second signals S₂ and the third signals S₃ using various types of training scenarios and modeling. In particular, the processor 232 can be trained or programmed to distinguish the third signals S₃ from the first signals S₁ and from the second signals S₂ to judge, from the third signals S₃, that the entrapment incident is in effect and to subsequently take the mitigation action.

With reference to FIG. 7, a method of operating an entrapment monitoring and detection system of an escalator system in which a moving step passes by ends of a brush of a balustrade at a step-skirt interface. The method includes scanning the step-skirt interface (block 701), determining whether results of the scanning are indicative of an object at the step-skirt interface (block 702), determining whether the results of the scanning are indicative of the object at the step-skirt interface persisting for a predetermined time (block 703) and judging that an entrapment is in effect or is imminent in accordance with the results of the scanning being indicative of the object at the step-skirt interface and persisting for the predetermined time (block 704). In addition, the method can also include taking a mitigation action to address the entrapment being in effect or imminent (block 705), such as by at least one or more of activating a warning light to emit a first color, activating the warning light to emit a second color and braking or slowing the escalator system.

With reference to FIG. 8, an example method of operating an entrapment monitoring and detection system of an escalator system in which a moving step passes by ends of a brush of a balustrade at a step-skirt interface is provided. The method includes two main components. The first is an object sensing and tracking component and the second is an entrapment identification and response component.

As shown in FIG. 8, in the object sensing and tracking component, the method includes scanning the step-skirt interface (block 801) and determining whether results of the scanning are indicative of an object at the step-skirt interface by showing that a detected range is less than a predefined scan length (block 802). If results of the determining of block 802 are negative, the method includes deleting an object reference and zeroing an object scan counter (block 803) whereupon control reverts to the scanning of block 801. If results of the determining of block 802 are affirmative, the method includes determining whether a new range is consistent with a prior identified object (block 804) taking into account the frame of reference in moving at the escalator running speed. If results of the determining of block 804 are negative, the method includes redefining an object reference and resetting the object scan counter to one (block 805) whereupon control reverts to the scanning of block 801. If results of the determining of block 804 are affirmative, the method includes successively incrementing the object scan counter (block 806).

At this point, in the entrapment identification and response component, the method includes determining whether the object scan counter has a value which is greater than N-action (block 807) and, if so, initiating an entrapment mitigation action (block 808), such as escalator shutdown. Here, N-action is a value of the object scan counter that is predefined to be associated with an entrapment incident that needs to be mitigated. If not, the method further includes determining whether the object scan counter has a value which is greater than N-alarm (block 809) and, if so, sending out an alarm indication at a location of the object (block 810), such as a red alarm light being emitted by local LEDs, whereupon control reverts to the scanning of block 801. Here, N-alarm is a value of the object scan counter that is predefined to be associated with an imminent or potential entrapment incident that may need to be mitigated in the near future but does not yet warrant escalator shutdown. If not, the method further includes determining whether the object scan counter has a value which is greater than N-warning (block 811) and, if so, sending out a warning indication at a location of the object (block 812), such as an orange warning light being emitted by the local LEDs, whereupon control reverts to the scanning of block 801. Here, N-warning is a value of the object scan counter that is predefined to be associated with a slight potential for an entrapment incident that may need to be mitigated but does not yet warrant an alarm. If not, control reverts to the scanning of block 801.

The three levels of the system response described above with reference to FIG. 8 in particular are an example illustration of one implementation of the method of detection. Alternate configurations with additional or fewer levels could also be used in such a detection system.

Technical effects and benefits of the present disclosure are the provision of a fast-responding, retrofittable detection system that can monitor and detect entrapment hazards in escalators as the step/skirt interfaces. The system can be used to create a focused indication of the exact location of the detected entrapment hazard to give riding passengers a warning to avoid a true entrapment and could, if deemed useful, provide a signal to initiate a braking response.

The corresponding structures, materials, acts and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the technical concepts in the form disclosed. Many modifications and variations will be apparent to those of ordinary skill in the art without departing from the scope and spirit of the disclosure. The embodiments were chosen and described in order to best explain the principles of the disclosure and the practical application and to enable others of ordinary skill in the art to understand the disclosure for various embodiments with various modifications as are suited to the particular use contemplated.

While the preferred embodiments to the disclosure have been described, it will be understood that those skilled in the art, both now and in the future, may make various improvements and enhancements which fall within the scope of the claims which follow. These claims should be construed to maintain the proper protection for the disclosure first described.

What is claimed is:

1. An escalator system, comprising:
a balustrade comprising a skirt with a brush;
a moving step, which is drivable to move in a conveyance direction along the balustrade to form a step-skirt interface between ends of the brush of the skirt and a corresponding side of the moving step; and
an entrapment monitoring and detection system comprising:
a sensor disposed at the step-skirt interface and configured to sense an object being present at the step-skirt interface; and
a processor configured to determine whether the sensor senses the object being present at the step-skirt interface for a predetermined time.

2. The escalator system according to claim 1, wherein the sensor comprises multiple sensors that sense in a same direction or in multiple directions.

3. The escalator system according to claim 1, wherein the sensor is a LiDAR sensor.

4. The escalator system according to claim 1, wherein the sensor is a RADAR sensor.

5. The escalator system according to claim 1, wherein the sensor is a camera.

6. The escalator system according to claim 1, wherein the sensor is one or more of a LiDAR sensor, a RADAR sensor or a camera.

7. The escalator system according to claim 1, wherein:
the sensor is configured to execute periodic sensing and is further configured to generate signals during the periodic sensing which are receivable and readable by the processor, and
wherein:
when no object is present at the step-skirt interface, the signals are first signals and are reflective of a predetermined length along the balustrade for which the sensor is responsible,
when an object is present at the step-skirt interface for less than the predetermined time, the signals deviate from the first signals and persist for less than the predetermined time, and
when an object is present at the step-skirt interface for at least the predetermined time, the signals deviate from the first signals and persist for at least the predetermined time.

8. The escalator system according to claim 1, further comprising light emitting diodes (LEDs) arranged along the balustrade and controllable by the entrapment monitoring and detection system to emit light in response to the processor determining that the sensor senses the object being present at the step-skirt interface for the predetermined time.

9. The escalator system according to claim 1, wherein:
the processor is further configured to judge that an entrapment incident is in effect or is imminent in accordance with an affirmative determination that the sensor senses the object being present at the step-skirt interface for the predetermined time and to take a mitigation action accordingly, and
the mitigation action comprises at least one or more of activating a warning light to emit a first color, activating the warning light to emit a second color and braking or slowing the escalator system.

10. An escalator system, comprising:
balustrades, each comprising a skirt with a brush;
a moving step, which is drivable to move in a conveyance direction between the balustrades to form step-skirt interfaces between ends of each brush and corresponding sides of the moving step; and
an entrapment monitoring and detection system comprising:
a sensor disposed at each step-skirt interface and configured to sense an object being present at each step-skirt interface; and
a processor configured to determine whether either sensor senses the object being present at either step-skirt interface for a predetermined time, to judge that an entrapment incident is in effect or is imminent in accordance with an affirmative determination that either sensor senses the object being present at either step-skirt interface for the predetermined time and to take a mitigation action accordingly.

11. The escalator system according to claim 10, wherein the sensor at each step-skirt interface comprises multiple sensors that sense in a same direction or in multiple directions.

12. The escalator system according to claim 10, wherein the sensor at each step-skirt interface is a LiDAR sensor.

13. The escalator system according to claim 10, wherein the sensor at each step-skirt interface is a RADAR sensor.

14. The escalator system according to claim 10, wherein the sensor at each step-skirt interface is a camera.

15. The escalator system according to claim 10, wherein the sensor at each step-skirt interface is one or more of a LiDAR sensor, a RADAR sensor or a camera.

16. The escalator system according to claim 10, wherein:
the sensor at each step-skirt interface is configured to execute periodic sensing and is further configured to generate signals during the periodic sensing which are receivable and readable by the processor, and
wherein:
when no object is present at either step-skirt interface, the signals of each sensor are first signals and are reflective of a predetermined length along the balustrades for which each sensor is responsible,
when an object is present at either step-skirt interface for less than the predetermined time, the signals of the corresponding sensor deviate from the first signals and persist for less than the predetermined time, and
when an object is present at either step-skirt interface for at least the predetermined time, the signals of the corresponding sensor deviate from the first signals and persist for at least the predetermined time.

17. The escalator system according to claim 10, further comprising light emitting diodes (LEDs) arranged along each of the balustrades and controllable by the entrapment monitoring and detection system to emit light in response to the processor determining that either sensor senses the object being present at the step-skirt interface for the predetermined time.

18. The escalator system according to claim 10, wherein:
the processor is further configured to judge that an entrapment incident is in effect or is imminent in accordance with an affirmative determination that either sensor senses the object being present at the corresponding step-skirt interface for the predetermined time and to take a mitigation action accordingly, and
the mitigation action comprises at least one or more of activating a warning light to emit a first color, activating the warning light to emit a second color and braking or slowing the escalator system.

19. A method of operating an entrapment monitoring and detection system of an escalator system in which a moving step passes by ends of a brush of a balustrade at a step-skirt interface, the method comprising:
scanning the step-skirt interface;
determining whether results of the scanning are indicative of an object at the step-skirt interface;
determining whether the results of the scanning are indicative of the object at the step-skirt interface persisting for a predetermined time; and
judging that an entrapment is in effect or imminent in accordance with the results of the scanning being indicative of the object at the step-skirt interface and persisting for the predetermined time.

20. The method according to claim 19, further comprising taking a mitigation action to address the entrapment being in effect or imminent,
the mitigation action comprising at least one or more of activating a warning light to emit a first color, activating the warning light to emit a second color and braking or slowing the escalator system.
